(19) United States
(12) Patent Application Publication
(10) Pub. No.: US 2020/0041124 A1
(43) Pub. Date: Feb. 6, 2020

(54) APPARATUS FOR KEEPING GERMS AWAY WHILE EXTINGUISHING CANDLES

(71) Applicants: Jackie White, Broadview, IL (US); Zelma White, Broadview, IL (US)

(72) Inventors: Jackie White, Broadview, IL (US); Zelma White, Broadview, IL (US)

(21) Appl. No.: 16/054,044

(22) Filed: Aug. 3, 2018

(51) Int. Cl. F23Q 25/00; B01D 46/00

(52) U.S. Cl. CPC F23Q 25/00; B01D 46/0017

(57) ABSTRACT

A device for keeping germs away from food is presented. The device has a tube with an inner portion, an outer portion, a proximal end and a distal end. A first opening of the tube that is coupled to the proximal end of the tube. A second opening of the tube that is coupled to the distal end of the tube. A filter is placed in the tube between the first and second openings to filter the germs from the air being blown.

### FIELD OF THE INVENTION

This invention relates to methods and apparatus for canning food products. More particularly, it relates to method and apparatus which are suitable for use in home canning operations.

### BACKGROUND

One concern during birthday parties and other celebrations is preventing contamination of the desserts for those situations where the celebrant is required to blow out candles. For example, during birthday parties it is often the case that a child may be sick on their birthday. In such a circumstance the sick child may have a runny nose, a cough, or other less than sanitary conditions. It is sometimes the case that older celebrants may have less than full control of their faculties where blowing on a cake or other dessert is required.

It is often the case that the celebrant may produce spittle or other moisture while blowing out the candles. Other projectiles have also been known to leave a celebrant's mouth while blowing on the candles.

Heretofore, there have been less than desirable solutions for protecting the dessert that contains the candles, while also maintaining the dignity of the celebrant. For this reason a device is needed that protects a dessert from contamination while a celebrant blows out the candles on a birthday cake or other dessert.

### BRIEF DESCRIPTION OF THE DRAWINGS

FIG. 1 is an exploded view of an embodiment of a sanitary extinguisher for extinguishing birthday cake candles.

FIG. 2 is a perspective view of the sanitary extinguisher of FIG. 1.

FIG. 3 is the sanitary extinguisher to extinguish the candles on a birthday cake.

### DETAILED DESCRIPTION

Reference will now be made in detail to the present preferred embodiments, examples of which are illustrated in the accompanying drawings. All terms in the plural shall also be taken as singular and vice-versa. Further, any reference to he shall also be applicable to she and vice-versa.

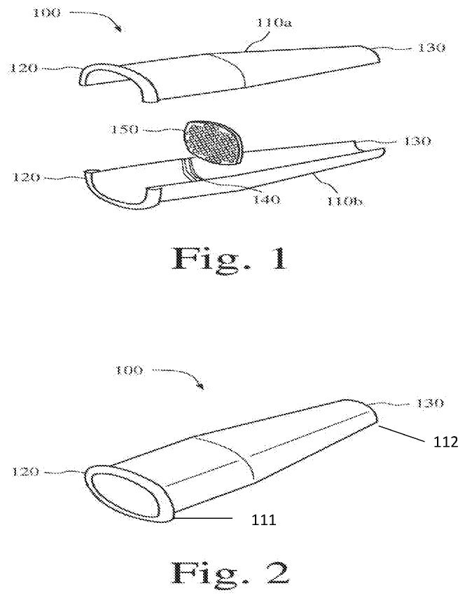

Referring to FIG. 1, is an exploded view of one embodiment of a sanitary extinguisher 100 for extinguishing birthday cake candles. FIG. 2 is a perspective view of the sanitary extinguisher 100.

The sanitary extinguisher 100 includes a tube 110 and a filter 150. The filter 150 may be replaceable or a permanent fixture of the sanitary extinguisher 100. The filter 150 may be paper, metal, mesh, etc. The tube 110 may be plastic, metal, etc. The tube 110 may be of any shape including, but not limited to, a pipe like shape, a kazoo shape, etc.

In one embodiment, two tube sections 110a, 110b are adjoined to form a generally tubular and substantially hollow tube 110. The tube 100 has a proximal end 111 and a distal end 112.

The filter 150 fits between the tube sections 110a, 110b into a slot 140. The slot 140 is grooved so that the filter 150 fits into the slot 140 and filters substantially the entire cross section of the tube 110. Each tube section 110a, 110b includes a slot 140 for the filter 150. The filter 150 fits within the slots 140 of each tube section 110a, 110b so that the filter 150 does not become dislodged.

The tube 110 includes a first opening 120 at the proximal end of the tube 110. Each tube section 110a, 110b includes a first opening 120. With the tube sections 110a, 110b adjoined, the first opening 120 encircles the larger end of the tube 110.

The first opening 120 at the large end of the tube 110 corresponds to the mouthpiece of the sanitary extinguisher 100. The first opening end 120 of the tube 110 is larger than the second opening 130 at the distal end 112 of the tube 110.

Those of skill in the art will readily appreciate that the tube 110 may include any number of tube sections adjoined to adjacent tube sections to form a generally tubular and substantially hollow tube 110 for the sanitary extinguisher 100.

The sanitary extinguisher 100 is used by placing the mouth upon the first opening 120. The first opening 120 provides for improved grip between the teeth or lips of the user. The user blows air into the sanitary extinguisher 100 at the first opening 120, through the filter 150, and the air exits through the second opening 130.

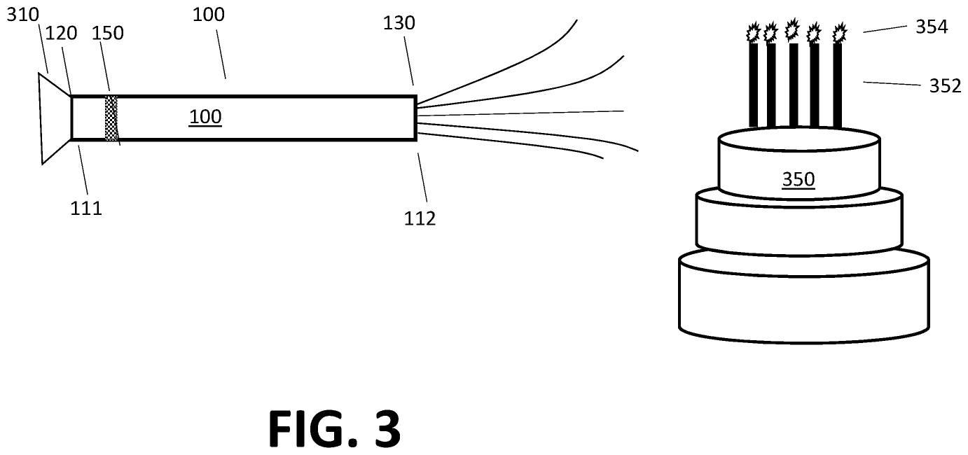

Moving now to FIG. 3, a view of the sanitary extinguisher blowing out birthday cake candles is discussed. The sanitary extinguisher 100 further has a mouthpiece 310, the mouthpiece 310 may be made of any material, such as plastic, PVC, metal, etc. The mouthpiece 310 may have any shape that comfortably fits the mouth and/or lips of an individual using the sanitary extinguisher. The mouthpiece 310 is coupled to the first opening 120 of the tube 110.

The tube 110 has a third opening 320. The third opening 320 is between the proximal end 111 and the distal end 112 of the tube 110. The mouthpiece 310 is coupled to the first opening 120 or the proximal end 111 of the tube 110.

A person wishing to extinguish the flames 354 of the candles 352 on a cake 350 places the sanitary extinguisher 100 near their mouth. The person, presses their lips substantially near the mouthpiece 310 of the sanitary extinguisher 100.

The person then blows into the mouthpiece 310. The air blown by the person is pushed thru the mouthpiece 310 and passes through the filter 150. The air blown then continues through the tube 110 and is expelled through the second opening 130.

The air blown rushes towards the flames 354 of the candles 352 of the cake 350 and extinguishes the flames 354 safely and without passing germs thus the sanitary extinguisher pushes the germs away from the air being blown. Thus, all around and eating the cakes will not be subject to unsanitary conditions.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A device for keeping germs away from food, the device comprising:
a tube, the tube having an inner portion, an outer portion, a proximal end and a distal end;
a first opening of the tube, wherein the first opening is coupled to the proximal end of the tube;
a second opening of the tube, wherein the second opening is coupled to the distal end of the tube; and
a filter, the filter being coupled to the inner portion of the tube substantially near the proximal end of the tube for filtering air.

2. The device of claim 1 further comprising a third opening in the tube wherein the third opening in the tube being substantially near the proximal end of the tube.

3. The device of claim 1, wherein the filter being placed in the third opening in the tube.

4. The device of claim 1, wherein filter is removable.

5. The device of claim 1, wherein the filter being a paper.

6. The device of claim 1, wherein the filter being a metal.

7. The device of claim 1, wherein the filter being a mesh.

8. The device of claim 1, wherein the filter being permanently coupled to the tube.

9. The device of claim 1 further comprising a mouthpiece, the mouthpiece having an opening, the opening of the mouthpiece coupled to the first opening of the tube.

10. The device of claim 1, wherein the mouthpiece being plastic.

11. The device of claim 1 wherein mouthpiece being metal.
